(19) United States
(12) Patent Application Publication
(10) Pub. No.: US 2014/0343244 A1
(43) Pub. Date: Nov. 20, 2014

(54) METHODS FOR PREPARATION OF POLYESTER OLIGOMER VIA BASE CATALYSIS

(71) Applicant: Liquid Thermo Plastics, Inc., Milwaukee, WI (US)

(72) Inventors: Jimmy Lynn Webb, Ballston Lake, NY (US); John Lippert, III, Schenectady, NY (US); James Mihalich, Shrewsbury, MA (US)

(73) Assignee: Liquid Thermo Plastics, Inc., Milwaukee, WI (US)

(21) Appl. No.: 14/209,495

(22) Filed: Mar. 13, 2014

Related U.S. Application Data
(60) Provisional application No. 61/780,608, filed on Mar. 13, 2013.

(51) Int. Cl. C08G 63/87; C08G 63/83

(52) U.S. Cl. CPC C08G 63/87; C08G 63/83
USPC 528/182; 528/274; 528/275

(57) ABSTRACT

The invention relates to methods and systems for preparing macrocyclic polyester oligomer (MPO) via base catalysis. It is found that base catalysts are effective in the production of MPO, and they reduce the potential for undesired byproducts such as furans (e.g., THF) and acetaldehyde, which result from diol side reactions.

### CROSS REFERENCE TO RELATED APPLICATIONS

The present application claims priority to U.S. provisional patent application No. 61/780,608, filed Mar. 13, 2013, the entire contents of each of which are hereby incorporated by reference herein.

### FIELD OF THE INVENTION

This invention relates generally to methods for preparing macrocyclic polyester oligomer (MPO). More particularly, in certain embodiments, the invention relates to methods for preparing macrocyclic polyester oligomer using a base catalyst.

### BACKGROUND OF THE INVENTION

Macrocyclic polyester oligomers (MPOs) have unique properties that make them attractive as matrix-forming resins for engineering thermoplastic composites. MPOs lend valuable characteristics to polymerized products, for example, high strength, high gloss, and solvent resistance. Furthermore, because certain MPOs melt and polymerize at temperatures well below the melting point of the resulting polymer, polymerization and crystallization can occur virtually isothermally upon melting of the MPO in the presence of an appropriate catalyst. The time and expense required to thermally cycle a tool is favorably reduced, because demolding can take place immediately following polymerization, without first cooling the mold.

Various methods for preparing MPO by depolymerizing polyesters have been described. For example, polybutylene terephthalate (PBT) and other polyalkylene terephthalates may be depolymerized to form macrocyclic polyester oligomers (MPOs), including, for example, the cyclic form of poly(1,4-butylene terephthalate) (cPBT). See, e.g., co-owned U.S. Pat. No. 5,039,783 by Brunelle et al., U.S. Pat. No. 5,231,161 by Brunelle et al., U.S. Pat. No. 5,407,984 by Brunelle et al., U.S. Pat. No. 5,668,186 by Brunelle et al., U.S. Pat. No. 6,525,164, by Faler, U.S. Pat. No. 6,787,632 by Phelps et al.; U.S. Pat. No. 7,732,557 by Phelps et al.; U.S. Pat. No. 7,750,109 by Phelps et al.; and U.S. Pat. No. 7,767,781 Phelps et al.; the texts of which are all incorporated by reference herein in their entirety.

The depolymerization reaction is an equilibrium reaction that progresses relatively slowly and produces undesired byproducts, including hydroxybutylester linear oligomers (referred to herein as “linears”), which must be separated from the product stream, or recycled. These byproducts are typically gellular in nature, and are physically difficult to filter or otherwise remove from solution. Furthermore, the above depolymerization methods require precipitation and removal of catalyst residue from the reaction solution. The separation, extraction, and/or recycle of linears and/or catalyst residue necessitate added process steps and unit operations in the manufacture of MPOs, thereby increasing both capital expense and operating costs.

A newer method of producing MPOs is described in U.S. Patent Application Publication No. US 2012/0302721, the text of which is incorporated by reference herein in its entirety. This method produces MPO directly from monomer, rather than by depolymerizing a polyester. Heterogeneous catalysis is used, which obviates performing a depolymerization reaction in solution. For example, the application describes use of titanium catalyst coated on solid support in a packed bed or column. MPO is produced in the reaction mixture, while residual linears and catalyst residue remain in the column, thereby reducing or obviating the filtration required for separating out the MPO produced.

There remains a need for a fast, efficient, less costly method of manufacturing MPO.

### SUMMARY OF THE INVENTION

Presented herein are methods and systems for preparing macrocyclic polyester oligomer (MPO) directly from monomer (rather than by depolymerizing a polyester), in which base catalysis is employed. It is found that base catalysts are effective in the production of MPO, and they reduce the potential for undesired byproducts such as furans (e.g., THF) and acetaldehyde, which result from diol side reactions.

For example, metal alkoxides such as sodium methoxide or potassium methoxide are found as effective base catalysts in the production of cyclic esters from diols and diesters. The potential for production of THF from diol side reactions is reduced in comparison to the use of acidic or neutral catalysts such as organo-titanates, for example.

Furthermore, organic bases such as triazabicyclodecene (TBD) are found to be particularly efficient catalysts, in that they appear to allow short oligomer to grow on the catalyst, and MPO is ‘spun off’ the catalyst. Lower amounts of catalyst are needed, and the potential for furan or acetaldehyde production is low.

Further synergy is achieved by use of a suitable solvent that compliments the selected catalyst and enables intermediates to stay in solution while allowing MPO to be crystallized out of solution upon cooling, thereby eliminating or reducing evaporation of solvent and allowing efficient isolation of product MPO. Various examples of such solvents are described herein. For example, experimental results using dodecane and drakesol 165, a light petroleum distillate, are presented herein.

Moreover, it has been found that use of a phenol di-ester such as diphenyl terephthalate (DPT) in the transesterification eliminates or reduces methanolysis. For example, an initial stage may involve reacting terephthalic acid and phenol in an esterification reactor to produce DPT, which is fed into a transesterification reactor in which the base-catalyzed production of MPO described herein takes place. Phenol is evolved and fed back into the esterification reactor.

In one aspect of the invention, MPO is prepared by a method comprising the steps of (a) heating a reaction mixture comprising (i) an alcohol, phenol, or both; (ii) a terephthalate (e.g., DMT or DPT) or, alternatively or additionally, a terephthalate precursor (e.g., TPA); (iii) a base (e.g., an organic base); and (iv) an organic solvent (different from the species in (i), (ii), and (iii) above), thereby forming MPO and polyester linears; and (b) separating the MPO from the reaction mixture.

In some embodiments, the MPO precipitates (e.g., crystallizes) out of the reaction mixture at a different temperature than the polyester linears, and the step (b) of separating the MPO comprises maintaining the reaction mixture within a temperature range in which the polyester linears substantially precipitate out of the reaction mixture (e.g., at least about 80 wt. % of the polyester linears in solution precipitate out), but in which the MPO substantially does not precipitate out of the reaction mixture (e.g., at least about 80 wt. % of the MPO in solution stays in solution).

In some embodiments, a substantial portion of the base associates with (e.g., adsorbs to, binds to, attaches to) the polyester linears, and step (b) comprises maintaining the reaction mixture temperature within a temperature range such that the polyester linears with the substantial portion of the base associated therewith substantially precipitate out of the reaction mixture, while the MPO substantially does not precipitate out of the reaction mixture.

In some embodiments, at least a portion of the base from the reaction mixture of step (a) precipitates out of the reaction mixture with at least a portion of the polyester linears formed, and at least a portion of the precipitated base is recovered and returned to the reaction mixture in step (a) for further use.

In some embodiments, the method comprises contacting a melt blend with one or more other components of the reaction mixture, wherein the melt blend comprises at least one of (A) terephthalic acid and isophthalic acid, and at least one of (B) hydroquinone and resorcinol.

In some embodiments, the method further comprises contacting terephthalic acid (TPA) and a single functional aromatic alcohol to produce a terephthalate that is then used in the reaction mixture of step (a). In some embodiments, the single functional aromatic alcohol is phenol and the terephthalate is DPT. In some embodiments, the single functional aromatic alcohol is cresol. In some embodiments, the step of contacting TPA and the single functional aromatic alcohol is performed at a temperature of at least 180° C. (e.g., about 300° C.). In some embodiments, the step of contacting TPA and the single functional aromatic alcohol is performed at a temperature of between about 230° C. and about 260° C.

In certain embodiments, the reaction mixture in step (a) is maintained at a solids content of no greater than about 5 wt. % solids (e.g., 1 wt. % solids).

In some embodiments, the reaction mixtures in step (a) occurs in an esterification reactor.

Features described with respect to other aspects of the invention can be applied to this aspect as well.

In another aspect, the present invention provides a process for preparing a MPO, the process comprising: (a) contacting terephthalic acid (TPA) and a single functional aromatic alcohol in an esterification reactor to produce a diester (e.g., DPT); (b) contacting the diester with a diol and a base catalyst in an organic solvent in a trans-esterification reactor, thereby forming MPO and polyester linears; and (c) removing and isolating the formed MPO. Such isolating may be done by a variety of techniques (e.g. liquid-liquid extraction, filtering, heat exchangers), including those described below.

In some embodiments, the process comprises selectively precipitating out of solution the polyester linears formed in the trans-esterification reactor (e.g., the MPO stays in solution and does not precipitate out of solution at the temperature at which polyester linears begin to precipitate out), wherein at least a portion of the base catalyst is associated with the polyester linears and precipitates out of solution with the polyester linears. In certain embodiments, the process comprises precipitating out of solution the MPO formed in the trans-esterification reactor following precipitation of the polyester linears out of solution. In some embodiments, the process further comprises isolating at least a portion of the base catalyst after it precipitates out of solution with the polyester linears and is removed from the trans-esterification reactor, and returning the portion of the base catalyst to the trans-esterification reactor (e.g., the recycled base catalyst substantially free of the polyester linears).

In some embodiments, the present invention relates to methods and systems for preparing linear polyester oligomer. The methods and systems for making such oligomers are similar to the methods and systems for making MPO, with the exception that the organic solvent is omitted. In some embodiments, the present invention provides a method for preparing a polyester via base-mediated organic reaction, the method comprising heating a reaction mixture, the reaction mixture comprising (i) an alcohol, phenol, or both; (ii) a diphenyl ester (e.g., DPT); and (iii) a base catalyst (e.g., an organic base), thereby forming a polyester. In some embodiments, the reaction mixture comprises a substituted or unsubstituted aromatic alcohol (e.g., a substituted phenol such as cresol).

Features described with respect to other aspects of the invention can be applied to this aspect as well.

In another aspect, the present invention provides a process for preparing polyester via base-mediated organic reaction, the process comprising (a) contacting terephthalic acid (TPA) and a single functional aromatic alcohol in an esterification reactor to produce a diester (e.g., DPT); and (b) contacting the diester with a diol and a base catalyst in a trans-esterification reactor, thereby forming polyester. In some embodiments, the single functional aromatic alcohol is phenol and the diester is diphenyl terephthalate (DPT).

In certain embodiments, the process further comprises performing a polycondensation reaction with polyester formed in a trans-esterification reactor, thereby increasing molecular weight of the polyester. In some embodiments, step (a) comprises heating a melt blend comprising at least one of (i) terephthalic acid and isophthalic acid, and at least one of (ii) hydroquinone and resorcinol. In some embodiments, the content of the esterification reactor is maintained at a temperature of at least 180° C. (e.g., about 300° C.). In some embodiments, the content of the trans-esterification reactor is maintained at a temperature of between about 230° C. and about 260° C.

Features described with respect to other aspects of the invention can be applied to this aspect as well.

In some embodiments of the methods and processes described herein, the diester is dimethyl terephthalate (DMT).

In some embodiments of the methods and processes described herein, the base catalyst is an organic base. In some embodiments, the base catalyst comprises triazabicyclodecene (TBD). In some embodiments, the base catalyst comprises one or both of sodium alkoxide (e.g., sodium methoxide) and potassium alkoxide (e.g., potassium methoxide).

In some embodiments of the methods and processes described herein, the reaction mixture comprises a diol. In some embodiments, the diol is polyethylene glycol. In some embodiments, the diol is butanediol.

In some embodiments of the methods and processes described herein, the reaction mixture comprises a phenol. In certain embodiments, the phenol is resorcinol. In other embodiments, the phenol is hydroquinone.

In some embodiments of the methods and processes described herein, the terephthalate is dimethyl terephthalate (DMT). In some embodiments, the terephthalate is diphenyl terephthalate (DPT).

In some embodiments of the methods and processes described herein, the organic solvent comprises a high-purity hydrocarbon solvent (e.g., Drakesol 165 (e.g., manufactured by Orica Chemicals), composed of acid treated light petroleum distillates). In some embodiments, the organic solvent comprises one or more components selected from the group consisting of oDCB (ortho-dichlorobenzene), toluene, o-xylene, pyridine, triethylamine, heptane, dibutyl ether, decane, and trichlorobenzene (TCB). In some embodiments, the organic solvent is toluene.

In some embodiments of the methods and processes described herein, no catalyst is used or than the base (e.g., the reaction is a base-mediated organic reaction). In some embodiments, no catalyst is used in the trans-esterification reactor other than the base (e.g., the trans-esterification reaction is base-mediated).

Embodiments of the invention may be performed as part of a continuous, semi-continuous, or batch process. Reactors may be single-stage or multi-stage. It is contemplated that methods of the invention may be combined or supplemented with reactors, systems, or processes that are known in the art.

Methods for the conversion of terephthalic acid (PTA) to DMT are known. Therefore, embodiments of the invention that employ DMT may alternatively employ PTA (purified or non-purified forms), for example, where DMT is formed from PTA. Similarly, the use of known chemical analogues and/or precursors of species described herein are considered to lie within the scope of the invention.

The MPO produced may be cPBT, cPPT, cPCT, cPET, cPEN, and/or copolymer oligomers thereof. The method may further include the step of collecting the MPO. In certain embodiments, the collected MPO is at least 80 wt. % dimer, trimer, tetramer, and/or pentamer species. In certain embodiments, the yield of MPO is at least 20%, 30% 35%, at least 40%, at least 45%, or at least 50%. In certain embodiments, a recycle stream may be used to improve yield.

Linear polyesters may be produced as well, including but not limited to PBT, PPT, PCT, PET, PEN, and/or copolymer oligomers thereof. In some embodiments, the polyester is PBT.

Various organic solvents may be used to practice the present invention, as described below. In some embodiments, an organic solvent comprises toluene.

Suitable base catalysts that may be used to practice the present invention include, but are not limited to, various organic and inorganic bases. In some embodiments, a base catalyst is a metal alkoxide. In some embodiments, a base catalyst is an amine base.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a flow diagram illustrating a process for preparing MPO according to an illustrative embodiment of the invention.

### DESCRIPTION OF THE ILLUSTRATIVE EMBODIMENT

Throughout the description, where compositions, mixtures, blends, and composites are described as having, including, or comprising specific components, or where processes and methods are described as having, including, or comprising specific steps, it is contemplated that, additionally, there are compositions, mixtures, blends, and composites of the present invention that consist essentially of, or consist of, the recited components, and that there are processes and methods of the present invention that consist essentially of, or consist of, the recited processing steps.

It should be understood that the order of steps or order for performing certain actions is immaterial so long as the invention remains operable. Moreover, two or more steps or actions may be conducted simultaneously.

Macrocyclic polyester oligomers that may be employed in this invention include, but are not limited to, macrocyclic poly(alkylene dicarboxylate) oligomers having a structural repeat unit of the formula:

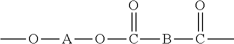

where A is an alkylene, or a cycloalkylene or a mono- or polyoxyalkylene group; and B is a divalent aromatic or alicyclic group.

Preferred macrocyclic polyester oligomers include macrocyclic poly(1,4-butylene terephthalate) (cPBT), macrocyclic poly(1,3-propylene terephthalate) (cPPT), macrocyclic poly(1,4-cyclohexylenedimethylene terephthalate) (cPCT), macrocyclic poly(ethylene terephthalate) (cPET), and macrocyclic poly(1,2-ethylene 2,6-naphthalenedicarboxylate) (cPEN) oligomers, and copolyester oligomers comprising two or more of the above monomer repeat units.

Methods of the invention may be used to produce macrocyclic homo- and co-polyester oligomers. In one embodiment, macrocyclic ester homo- and co-oligomers produced via methods of this invention include oligomers having a general structural repeat unit of the formula:

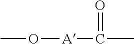

where A′ is an alkylene, cycloalkylene, or mono- or polyoxyalkylene group, and where A′ may be substituted, unsubstituted, branched, and/or linear. Example MPOs of this type include butyrolactone and caprolactone, where the degree of polymerization is one, and 2,5-dioxo-1,4-dioxane, and lactide, where degree of polymerization is two. The degree of polymerization may also be 3, 4, 5, or higher. Molecular structures of 2,5-dioxo-1,4-dioxane and lactide, respectively, appear below:

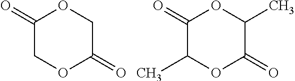

In general, a macrocyclic polyester oligomer (an MPO) produced via methods of the invention includes species of different degrees of polymerization, although, in certain embodiments, MPO with a high concentration of a particular species may be produced. Here, a degree of polymerization (DP) with respect to the MPO means the number of identifiable structural repeat units in the oligomeric backbone. The structural repeat units may have the same or different molecular structure. For example, an MPO may include dimer, trimer, tetramer, pentamer, and/or other species. In certain embodiments, the MPO is primarily (e.g., consists essentially of) dimer, trimer, tetramer, and/or pentamer species. In certain embodiments, the MPO is primarily (e.g., consists essentially of) trimer, tetramer, and/or pentamer species (e.g., C3+C4+C5).

Where methods of the invention refer to the use of a dialkyl terephthalate, such as DMT, those methods are also contemplated to include variations of the method in which terephthalic acid (TPA) is used instead of at least a portion of the dialkyl terephthalate. For example, it is contemplated that a method of the invention in which a reaction is performed using a dialkyl terephthalate and a diol inherently includes an adaptation in which terephthalic acid is used instead of (or in addition to) dialkyl terephthalate. For example, known methods for the conversion of TPA to DMT may be used. Similarly, the use of known chemical analogues and/or precursors of species described herein are considered to lie within the scope of the claimed subject matter.

It is contemplated that methods, systems, and processes of the claimed invention encompass scale-ups, variations, and adaptations developed using information from the embodiments described herein. For example, the invention includes pilot plant and plant-scale manufacturing processes whose feasibility is demonstrated by the laboratory-scale experiments described herein. The chemical reactions described herein may be performed using reactor equipment that is known to those of ordinary skill in the field of polymer manufacturing and processing, including, without limitation, for example, batch reactors, plug-flow reactors, continuously-stirred tank reactors, packed-bed reactors, slurry reactors, fluidized bed reactors, and columns. Chemical reactions described herein may be conducted in batch, semi-continuous, and/or continuous operation.

Scale-up of systems from laboratory to plant scale may be performed by those of ordinary skill in the field of polymer manufacturing and processing. For example, those of ordinary skill in this field may select reactor types, design experiments for obtaining kinetic data, develop and apply models for reactor design, develop economically optimum reactor design, and/or validate reactor designs via pilot plant and/or full scale reactor experiments. General information regarding reactors and the design of reactor systems for manufacture of products may be found, for example, in “Kinetics and Reaction Engineering,” John L. Falconer, editor, in The Engineering Handbook, Section X, Richard C. Dorf, editor-in-chief, CRC Press, Inc., ISBN 0-8493-8344-7, pp. 785-829 (1995).

Any suitable techniques for material separation, isolation, and purification may be adapted for application in manufacturing processes encompassed by various embodiments of the invention, for example, techniques for distillation, extraction, reactive extraction, adsorption, absorption, stripping, crystallization, evaporation, sublimation, diffusional separation, adsorptive bubble separation, membrane separation, and/or fluid-particle separation. General information regarding separation processes and their design may be found, for example, in “Separation Processes,” Klaus Timmerhaus, editor, in The Engineering Handbook, Section VIII, Richard C. Dorf, editor-in-chief, CRC Press, Inc., ISBN 0-8493-8344-7, pp. 579-657 (1995).

It is also contemplated that methods, systems, and processes of the claimed invention may include pumps, heat exchangers, and gas-, liquid-, and/or solid-phase material handling equipment known to those of ordinary skill in the field of polymer manufacturing and processing.

Embodiments of the invention may be performed as part of a continuous, semi-continuous, or batch process. Reactors may be single-stage or multi-stage. It is contemplated that methods of the invention may be combined or supplemented with reactors, systems, or processes that are known in the art.

The mention herein of any publication, for example, in the Background section, is not an admission that the publication serves as prior art with respect to any of the claims presented herein. The Background section is presented for purposes of clarity and is not meant as a description of prior art with respect to any claim.

As used herein, “macrocyclic” is understood to mean a cyclic molecule having at least one ring within its molecular structure that contains 5 or more atoms covalently connected to form the ring.

As used herein, an “oligomer” is understood to mean a molecule that contains one or more identifiable structural repeat units of the same or different formula.

As used herein, “macrocyclic polyester oligomer” (MPO), or “cyclics”, is understood to mean macrocyclic oligomer containing structural repeat units having an ester functionality. A macrocyclic polyester oligomer typically refers to multiple molecules of one specific repeat unit formula. However, a macrocyclic polyester oligomer also may include multiple molecules of different or mixed formulae having varying numbers of the same or different structural repeat units. Thus, the terms “macrocyclic polyester oligomer” and “macrocyclic polyester oligomers” (plural form) may be used interchangeably. Also, the terms “macrocyclic polyester oligomer” and “macrocyclic oligoester” are used interchangeably herein. A macrocyclic polyester oligomer may be a co-polyester or multi-component polyester oligomer, i.e., an oligomer having two or more different structural repeat units having ester functionality within one cyclic molecule.

As used herein, “substantially homo- or co-polyester oligomer” is understood to mean a polyester oligomer wherein the structural repeat units are substantially identical or substantially composed of two or more different structural repeat units, respectively. Unless otherwise noted, the polyester oligomers described herein include substantially homo-polyester oligomers as well as substantially co-polyester oligomers.

Various organic solvents may be used to practice the present invention. In some embodiments, the organic solvent is a high-purity hydrocarbon solvent, for example, such as Drakesol 165, manufactured by Orica Chemicals, which is composed of acid-treated light petroleum distillates. Other similar solvents may be used, as well. In some embodiments, the organic solvent may include at least one member selected from the group consisting of dibutyl ether, decane, dodecane, tetradecane, hexadecane, octadecane, heptane, toluene, xylene, trimethylbenzene, tetramethylbenzene, ethylbenzene, propylbenzene, naphthalene, methylnaphthalene, biphenyl, triphenyl, diphyenyl ether (or a halogenated derivative thereof), anisol, pyridine, triethylamine, methylene chloride, dimethyoxybenzene, chlorobenzene, dichlorobenzene, trichlorobenzene, chloronaphthalene, dichloronaphthalene, and/or a perfluorocarbon. In particular embodiments, the organic solvent may include oDCB, toluene, o-xylene, pyridine, triethylamine, heptane, dibutyl ether, decane, dodecane, or trichlorobenzene (TCB). In some embodiments, the organic solvent may include toluene.

Base catalysts that may be used to practice the invention include known organic, inorganic bases, and combinations thereof. In certain embodiments, the base catalyst is an organic base. In some embodiments, the catalyst is an amine. In some embodiments, the base catalyst is a tertiary amine. In some embodiments, a catalyst is a trialkylamine, dialkylamine or partially unsaturated or aromatic heterocyclic amine. In some embodiments, the base catalyst is triethylamine, DIPEA, N-methyl morpholine, DABCO, diisopropylamine, DBU, DMAP, PPTS, triazabicyclodecene (TBD), or imidazole. In some embodiments, the base catalyst is TBD.

In some embodiments, a base catalyst is a metal alkoxides or carbonate. In some embodiments, a base catalyst is sodium bicarbonate, sodium carbonate, or potassium carbonate. In some embodiments, a base catalyst is a sodium or potassium alkoxide. In some embodiments, a base catalyst is sodium methoxide. In other embodiments, a base catalyst is potassium methoxide.

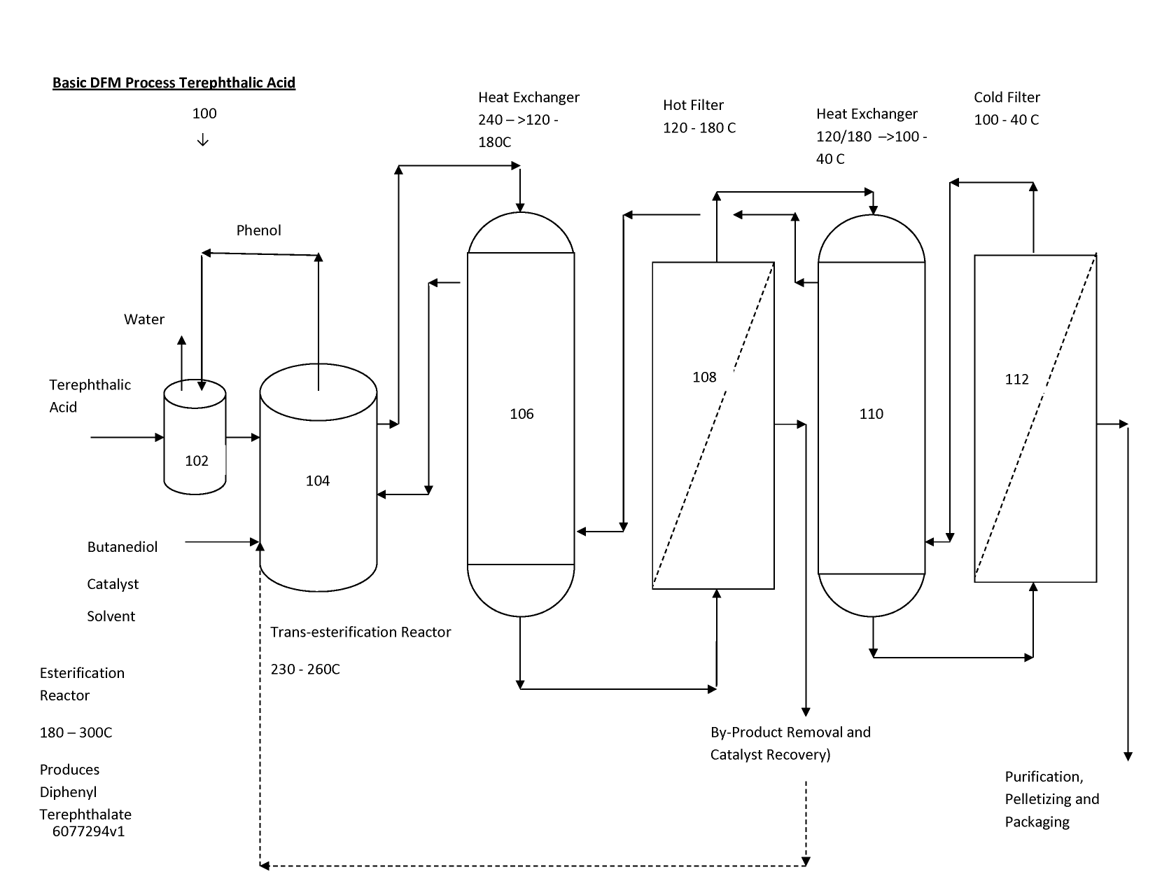

FIG. 1 is a schematic diagram of a process 100 for preparing MPO according to an illustrative embodiment. Certain embodiments involve methods and processes for performing the trans-esterification reaction of the reactor 104. Other embodiments involve methods and processes for performing an initial esterification reaction 102 to produce a product (e.g., a diester such as DPT) that is fed into the trans-esterification reactor 104. Other embodiments additionally involve performing a separation of MPO from a product stream, e.g., by running the product through a first heat exchanger 106, through a hot filter 108, through a second heat exchanger 110, and/or through a cold filter 112, after which the remaining MPO product is sent for purification, pelletization, and/or packaging.

In one example, terephthalic acid and phenol are fed into the esterification reactor 102, which takes place at a temperature from about 180° C. to about 300° C. The reaction produces H₂O, which is released. At least a portion of the phenol fed into the esterification reactor 102 may be the phenol that is produced in the trans-esterification reactor 104 and recycled into the esterification reactor 102. The product of the esterification reactor 102 in this example is DPT.

The DPT produced in the esterification reactor 102 is fed into the trans-esterification reactor 104, along with butanediol, base catalyst, and solvent, examples of which are described herein. The reaction mixture is maintained at a temperature from about 230° C. to about 260° C. in the trans-esterification reactor. One example of a base catalyst that is found to work particularly well is TBD. The phenol is more easily replaced as an end group by the diol and has a favorable equilibrium with the desired diol. Use of phenol makes the reaction much faster than use of a methyl, ethyl, or butyl end group, for example. The base catalyst does not react with the diol, so no THF or acetaldehyde is formed. The reaction is run at low solids concentration (e.g., at a concentration no greater than about 5 wt. %, no greater than about 4 wt. %, no greater than about 3 wt. %, no greater than about 2 wt. %, or no greater than about 1 wt. %). The evolved phenol is redirected back into the esterification reactor 102, while a product stream proceeds into the first heat exchanger 106.

Separation of MPO from the reaction mixture leaving the trans-esterification reactor is performed by reducing the temperature of the reaction mixture. The reaction mixture is maintained within a temperature range in which the polyester linears that are produced substantially precipitate out of the reaction mixture (e.g., at least about 80 wt. % of the polyester linears in solution precipitate out), but in which the MPO substantially does not precipitate out of the reaction mixture (e.g., at least about 80 wt. % of the MPO in solution stays in solution). A substantial portion of the base catalyst associates with (e.g., adsorbs to, binds to, or attaches to) the polyester linears, so a substantial portion of the base catalyst (e.g., at least about 95 wt. %, at least about 98 wt. %, at least about 99 wt. %, at least about 99.5 wt. %, or at least about 99.9 wt. %) can be removed from the reaction mixture by precipitation. In the process 100 of FIG. 1, the recovered catalyst and/or recovered polyester linears may be recycled back into the trans-esterification reactor 104.

In certain embodiments, the first heat exchanger 106 takes the product reaction mixture from about 240° C. down to a temperature from about 120° C. to about 180° C. The product enters the hot filter 108, and the MPO-containing mixture proceeds to the second heat exchanger 110 while another portion is recycled to the first heat exchanger 106. The second heat exchanger 110 takes the feed down to a lower temperature, for example, from a temperature from 120° C.-180° C. to a temperature 40° C.-100° C., after which the product enters the cold filter 112. A portion of the mixture containing MPO is removed from the cold filter 112 for purification, pelletization, and packaging, while another portion of the mixture is fed back into the second heat exchanger 110.

### EXPERIMENTAL EXAMPLES

### General Experimental Procedure for the Synthesis of MPO

To a mixture of 1,4-butanediol (BDO) in solvent at a given temperature was added catalyst. DMT or DPT was then added to the mixture and the reaction maintained at the specified temperature. High pressure liquid chromatography analysis after a designated time showed that a mixture of cyclics were obtained, and area calculated. Results for specific experiments are shown in Table 1. DMT=dimethyl terephthalate; DPT=diphenyl terephthalate; TBD=1,5,7-triazabicyclo(4.4.0)dec-5-ene; DBU=1,8-Diazabicyclo[5.4.0]undec-7-ene.

TABLE 1

| | | | Catalyst | | | | | | | |
|---|---|---|---|---|---|---|---|---|---|---|
| Rxn | Solvent | Catalyst | Load | Ester | BDO Level | Temperature | Time | | Volume | HPLC Total % of Cx* |
| 1 | Toluene | NaOCH₃ | 1.4 | DMT | 2 | 111° C. | 1.5 | h | 40 mL | 21.4 |
| 2 | o-Xylene | NaOCH₃ | 1.4 | DMT | 2 | 144° C. | 2 | h | 40 mL | 0 |
| 3 | Toluene | NaOCH₃ | 1.1 | DMT | 1.1 | 111° C. | 2.5 | h | 40 mL | 42.2 |
| 4 | Pyridine | NaOCH₃ | 0.9 | DMT | 1.1 | 115° C. | 2 | h | 40 mL | 0 |
| 5 | Triethylamine | NaOCH₃ | 1.3 | DMT | 1.1 | 89° C. | 2 | h | 40 mL | 0 |
| 6 | Heptane | KOH | 1.1 | DMT | 1.1 | 98° C. | 2 | h | 40 mL | 0 |
| 7 | Dodecane | NaOCH₃ | 0.72 | DMT | 1.1 | 175° C. | 2 | h | 40 mL | 0 |
| 8 | Toluene | KOCH₃ | 1.1 | DMT | 1.1 | 111° C. | 2 | h | 40 mL | 25.2 |
| 9 | Toluene | TBD | 1.1 | DMT | 1.1 | 111° C. | 2 | h | 40 mL | 0 |
| 10 | Dibutyl Ether | TBD | 0.13 | DPT | 1 | 142° C. | 30 | min | 40 mL | 20.5 |
| 11 | Dibutyl Ether | NaOCH₃ | 0.13 | DPT | 1 | 142° C. | 1 | h | 40 mL | 7.4 |
| 12 | Heptane | TBD | 0.13 | DPT | 1 | 98° C. | 2 | h | 40 mL | 0 |
| 13 | Toluene | TBD | 0.13 | DPT | 1 | 111° C. | 30 | min | 40 mL | 17.9 |
| 14 | Decane | TBD | 0.13 | DPT | 1 | 174° C. | 30 | min | 40 mL | 31.6 |
| 15 | Dodecane | TBD | 0.13 | DMT | 1 | 214° C. | 30 | min | 40 mL | 14.8 |
| 16 | Dodecane | TBD | 0.06 | DPT | 1 | 214° C. | 15 | min | 40 mL | 43.9 |
| 17 | Dodecane | TBD | 0.06 | DPT | 2 | 214° C. | 15 | min | 40 mL | 18.2 |
| 18 | Dodecane | TBD | 0.13 | DPT | 2 | 214° C. | 15 | min | 40 mL | 24.7 |
| 19 | Dodecane | TBD | 0.13 | DPT | 1 | 214° C. | 15 | min | 40 mL | 41.7 |
| 20 | Dodecane | TBD | 0.06 | DPT | 1 | 185° C. | 20 | min | 40 mL | 14.7 |
| 21 | Dodecane | TBD | 0.06 | DPT | 2 | 185° C. | 20 | min | 40 mL | 11 |
| 22 | Dodecane | TBD | 0.13 | DPT | 2 | 185° C. | 20 | min | 40 mL | 10 |
| 23 | Dodecane | TBD | 0.13 | DPT | 1 | 185° C. | 20 | min | 40 mL | 32.4 |
| 24 | Dodecane | TBD | 0.04 | DPT | 1 | 214° C. | 40 | min | 30 mL | 36.6 |
| 25 | Dodecane | TBD | 0.04 | DPT | 1 | 214° C. | 30 | min | 50 mL | 46.2 |
| 26 | Dodecane | TBD | 0.08 | DPT | 1 | 214° C. | 30 | min | 30 mL | 29.3 |
| 27 | Dodecane | TBD | 0.08 | DPT | 1 | 214° C. | 30 | min | 50 mL | 32.9 |
| 28 | Dodecane | TBD | 0.03 | DPT | 1 | 214° C. | 40 | min | 50 mL | 46.3 |
| 29 | Dodecane | TBD | 0.02 | DPT | 1 | 214° C. | 40 | min | 50 mL | 50.7 |
| 30 | Dodecane | SiO₂•Ti | 3 g | DPT | 1 | 214° C. | 20 | min | 40 mL | 1.5 |
| 31 | Dodecane | SSP | 0.13 | DPT | 1 | 214° C. | 30 | min | 40 mL | 0 |
| 32 | Dodecane | NMeTBD | 0.13 | DPT | 1 | 214° C. | 30 | min | 40 mL | 2.2 |
| 33 | Dodecane | DBU | 0.13 | DPT | 1 | 214° C. | 15 | min | 40 mL | 3.5 |
| 34 | 80% Dod/20% | TBD | 0.13 | DPT | 1 | 214° C. | 20 | min | 40 mL | 25 |
| | TCB | | | | | | | | | |
| 35 | Drakesol 165 | TBD | 0.13 | DPT | 1 | 200° C. | 30 | min | 40 mL | 48.2 |
| 36 | Dodecane | TBD | 0.13 | DPT | 1 | RT | 72 | h | 40 mL | 11.8 |

*The integration % includes all byproducts and intermediates based on HPLC results

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

1. A method for preparing a macrocyclic polyester oligomer (MPO), the method comprising:
(a) heating a reaction mixture, the reaction mixture comprising:
(i) an alcohol, phenol, or both;
(ii) a terephthalate (e.g., DMT or DPT) or, alternatively or additionally, a terephthalate precursor (e.g., TPA);
(iii) a base catalyst (e.g., an organic base); and
(iv) an organic solvent (different from the species in (i), (ii), and (iii) above), thereby forming MPO and polyester linears; and
(b) separating the MPO from the reaction mixture.

2. The method of claim 1, wherein the MPO precipitates (e.g., crystallizes) out of the reaction mixture at a different temperature than the polyester linears, and step (b) comprises maintaining the reaction mixture within a temperature range in which the polyester linears substantially precipitate out of the reaction mixture (e.g., at least about 80 wt. % of the polyester linears in solution precipitate out) but in which the MPO substantially does not precipitate out of the reaction mixture (e.g., at least about 80 wt. % of the MPO in solution stays in solution).

3. The method of claim 2, wherein a substantial portion of the base catalyst associates with (e.g., adsorbs to, binds to, attaches to) the polyester linears, and step (b) comprises maintaining the reaction mixture temperature within a temperature range such that the polyester linears with the substantial portion of the base associated therewith substantially precipitate out of the reaction mixture, while the MPO substantially does not precipitate out of the reaction mixture.

4. The method of claim 1, wherein the base catalyst is an organic base.

5. The method of claim 4, wherein the base catalyst comprises triazabicyclodecene (TBD).

6. The method of claim 1, wherein the base catalyst comprises one or both of sodium alkoxide (e.g., sodium methoxide) and potassium alkoxide (e.g., potassium methoxide).

7. The method of claim 1, wherein the reaction mixture comprises a diol.

8. The method of claim 7, wherein the diol is polyethylene glycol.

9. The method of claim 7, wherein the diol is butanediol.

10. The method of claim 1, wherein the reaction mixture comprises a phenol.

11. The method of claim 10, wherein the phenol is resorcinol.

12. The method of claim 10, wherein the phenol is hydroquinone.

13. The method of claim 10, wherein the method comprises contacting a melt blend with one or more other components of the reaction mixture, wherein the melt blend comprises at least one of (A) terephthalic acid and isophthalic acid, and at least one of (B) hydroquinone and resorcinol.

14. The method of claim 1, wherein the terephthalate is dimethyl terephthalate (DMT).

15. The method of claim 1, wherein the terephthalate is diphenyl terephthalate (DPT).

16. The method of claim 1, wherein the organic solvent comprises a high-purity hydrocarbon solvent (e.g., Drakesol 165 (e.g., manufactured by Orica Chemicals), composed of acid treated light petroleum distillates).

17. The method of claim 1, wherein the organic solvent comprises one or more components selected from the group consisting of oDCB, toluene, o-xylene, pyridine, triethylamine, heptane, dibutyl ether, decane, dodecane, and trichlorobenzene (TCB).

18. The method of claim 17, wherein the organic solvent is toluene.

19. The method of claim 1, wherein the MPO is cyclic poly(butylene terephthalate) (cPBT).

20. The method of claim 1, wherein the MPO is a member selected from the group consisting of cPBT, cPPT, cPCT, cPET, and cPEN.

21. The method of claim 1, wherein the MPO is a copolymer oligomer.

22. The method of claim 1, wherein the MPO separated from the reaction mixture is at least 80 wt. % dimer, trimer, tetramer and/or pentamer species.

23. The method of claim 1, wherein the yield of MPO is at least 20% (e.g., at least 20%, at least 30%, at least 35%, at least 40%, at least 45%, at least 50%).

24. The method of claim 1, wherein no catalyst is used other than the base (e.g., the reaction is a base-mediated organic reaction).

25. The method of claim 1, wherein at least a portion of the base catalyst from the reaction mixture of step (a) precipitates out of the reaction mixture with at least a portion of the polyester linears formed, and at least a portion of the precipitated base catalyst is recovered and returned to the reaction mixture in step (a) for further use.

26. The method of claim 1, further comprising contacting terephthalic acid (TPA) and a single functional aromatic alcohol to produce a terephthalate that is then used in the reaction mixture of step (a).

27. The method of claim 26, wherein the single functional aromatic alcohol is phenol and the terephthalate is DPT.

28. The method of claim 26, wherein the single functional aromatic alcohol is cresol.

29. The method of claim 1, wherein the step of contacting TPA and the single functional aromatic alcohol is performed at a temperature of at least 180° C. (e.g., about 300° C.).

30. The method of claim 1, wherein the reaction mixture in step (a) is maintained at a solids content of no greater than about 5 wt. % solids (e.g., 1 wt. % solids).

31. A process for preparing a macrocyclic polyester oligomer (MPO), the process comprising:
(a) contacting terephthalic acid (TPA) and a single functional aromatic alcohol in an esterification reactor to produce a diester (e.g., DPT);
(b) contacting the diester with a diol and a base catalyst in an organic solvent in a trans-esterification reactor, thereby forming MPO and polyester linears; and
(c) removing and isolating the formed MPO.

32-52. (canceled)
